(19) United States
(12) Patent Application Publication
(10) Pub. No.: US 2008/0013025 A1
(43) Pub. Date: Jan. 17, 2008

(54) MULTI-DOMAIN HORIZONTAL ALIGNMENT LIQUID CRYSTAL DISPLAY PANEL

(75) Inventors: Da-Wei Wu, Taipei (TW); Meng-Chi Liou, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: CHUNGHWA PICTURE TUBES, LTD., Taipei (TW)

(21) Appl. No.: 11/456,842

(22) Filed: Jul. 11, 2006

(51) Int. Cl. G02F 1/1337

(52) U.S. Cl. 349/129

(57) ABSTRACT

A multi-domain horizontal alignment (MHA) liquid crystal display (LCD) panel is provided. The MHA LCD includes an active device array substrate, an opposing substrate and a liquid crystal layer. The opposing substrate has a common electrode layer. The active device array substrate includes a substrate, scan lines, data lines and pixel units. The scan lines and the data lines are disposed on the substrate and define L-shaped pixel areas thereon. The pixel units are disposed on the respective L-shaped pixel areas. Each pixel unit has an active device, a pixel electrode, and first and second alignment members. The pixel electrode and the active device are electrically connected. The first and the second alignment members are arranged perpendicular to each other on the pixel electrode, wherein the first alignment members are set at a 45 degree angle with respect to the horizontal direction.

### BACKGROUND OF THE INVENTION

1. Field of the Invention

The present invention relates to a liquid crystal display panel (LCD panel). More particularly, the present invention relates to a multi-domain horizontal alignment (MHA) LCD panel.

2. Description of the Related Art

Thin film transistor liquid crystal display device has become one of the mainstream display products in the market due to its many advantages including a high picture quality, a good spatial utilization, low power consumption and radiation-free. Some of the market demands for a liquid crystal display device are a high contrast ratio, rapid response and wide viewing angle. At present, the types of liquid crystal display devices that meet the demand for a wide viewing angle include at least the multi-domain vertical alignment (MVA) thin film transistor liquid crystal display device and the multi-domain horizontal alignment (MHA) thin film transistor liquid crystal display device.

FIG. 1 is a top view of a conventional thin film transistor array substrate used in a multi-domain horizontal alignment thin film transistor liquid crystal display panel. As shown in FIG. 1A, the conventional thin film transistor array substrate 100 comprises a substrate 110, scan lines 120, data lines 130, pixel units 140 and common lines 150. The scan lines 120, the data lines 130, the pixel units 140 and the common lines 150 are disposed on the substrate 110. The pixel units 140 are electrically connected to their corresponding scan lines 120 and corresponding data lines 130. Furthermore, each pixel unit 140 includes a thin film transistor 142 and a pixel electrode 144. The thin film transistor 142 is electrically connected to the corresponding scan line 120 and corresponding data line 130 and the pixel electrode 144 is electrically connected to the thin film transistor 142.

More specifically, each pixel electrode 144 has first slits 144a and second slits 144b. The first slits 144a and the second slits 144b are aligned in a direction perpendicular to each other. In addition, the first slits 144a and the scan lines 120 are roughly parallel to each other while the second slits 144b and the data lines 130 are roughly parallel to each other. The common line 150 has a geometric form resembling the letter H.

When the foregoing thin film transistor array substrate 100 and a color filter substrate (not shown) are assembled together and a liquid crystal (not shown) is injected into the space between the substrates, a multi-domain horizontal alignment (MHA) thin film transistor (TFT) liquid crystal display (LCD) panel is formed. Furthermore, a polarizing plate (not shown) is also disposed on the top and the bottom surface of the MHA TFT LCD panel. It should be noted that the polarizing directions of the two polarizing plates are 45 and 135 degree respectively. However, most polarizing plates in the market have a polarizing direction of either 0 or 90 degree, or in other words, a polarizing plate along the X axis or the Y axis. Therefore, the polarizing plates have to be specially tailored before using them inside a MHA TFT LCD panel. At present, the cost of the polarizing plate used in the MHA TFT LCD panel is about 1.4 times that of the conventional polarizing plate.

In addition, when the polarizing plates start to deform due to a high-temperature and high-humidity environment, the four sides of the MHA TFT LCD panel often have a white bias. In other words, the MHA TFT LCD panel has an edge mura problem.

### SUMMARY OF THE INVENTION

Accordingly, at least one objective of the present invention is to provide a multi-domain horizontal alignment liquid crystal display (MHA LCD) panel that can use the common X-Y axis aligned polarizing plates.

To achieve these and other advantages and in accordance with the purpose of the invention, as embodied and broadly described herein, the invention provides a multi-domain horizontal alignment liquid crystal display (MHA LCD) panel. The MHA LCD panel comprises an active device array substrate, an opposing substrate and a liquid crystal layer. The opposing substrate has a common electrode layer. The liquid crystal layer is disposed between the active device array substrate and the opposing substrate. The active device array substrate further includes a substrate, scan lines, data lines and pixel units. The scan lines and the data lines are disposed on the substrate. Furthermore, the scan lines and the data lines define L-shaped pixel areas on the substrate. The pixel units are disposed on the respective L-shaped pixel areas and controlled by the scan line and the data line. Each pixel unit has an active device, a pixel electrode, first alignment members and second alignment members. The active device is electrically connected to the corresponding scan line and the corresponding data line. The pixel electrode and the active device are electrically connected. The first and the second alignment members are disposed on the pixel electrode. The first alignment members are oriented in a direction perpendicular to the second alignment members. Moreover, the first alignment members are set at a 45 degree angle with respect to the horizontal direction.

In one embodiment of the present invention, the MHA LCD panel further includes a first polarizing plate and a second polarizing plate. The first polarizing plate is disposed on the surface of the opposing substrate far away from the liquid crystal layer and the second polarizing plate is disposed on the surface of the active device array substrate far away from the liquid crystal layer. In addition, the direction of polarization of the first polarizing plate is set at either a 0 or a 90 degree angle with respect to the horizontal direction. Meanwhile, the direction of polarization of the second polarizing plate is also set at either a 0 or a 90 degree angle with respect to the horizontal direction but complementary to the orientation of the first polarizing plate.

In one embodiment of the present invention, the active device array substrate further includes common lines disposed on the substrate.

In one embodiment of the present invention, each common line has T-shaped branches.

In one embodiment of the present invention, the total length of the first alignment members in each pixel unit is identical to the total length of the second alignment members.

In one embodiment of the present invention, each scan line has a jagged shape.

In one embodiment of the present invention, each data line has a jagged shape.

In one embodiment of the present invention, the first alignment members can be alignment protrusions or slits.

In one embodiment of the present invention, the second alignment members can be alignment protrusions or slits.

In brief, the present invention modifies the quantity and alignment direction of the alignment members such as alignment protrusions or slits to match the ordinary X-Y axis oriented polarizing plates. Hence, the production cost of the MHA LCD panel can be effectively reduced. Furthermore, with the deployment of ordinary X-Y axis oriented polarizing plate, edge mura problem appearing in the MHA LCD panels can be improved compared with that produced by the conventional technique.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of a conventional thin film transistor array substrate used in a multi-domain horizontal alignment thin film transistor liquid crystal display panel.

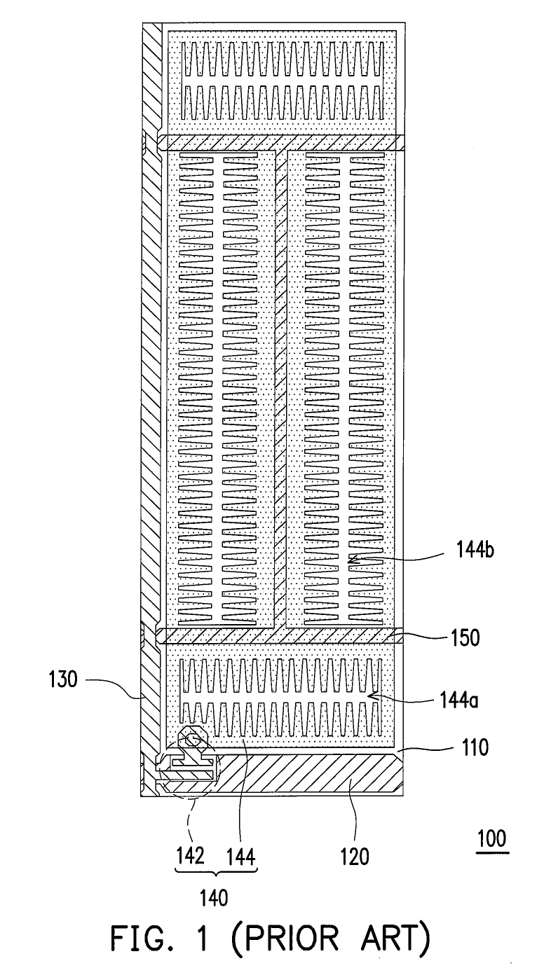

FIG. 2A is a schematic cross-sectional view of a multi-domain horizontal alignment liquid crystal display panel according to a first embodiment of the present invention.

FIG. 2B is a top view of the active device array substrate of FIG. 2A.

FIG. 2C is a cross-sectional view along line A-A′ of FIG. 2B.

FIG. 3 is a top view of an active device array substrate according to a second embodiment of the present invention.

FIG. 4 is a top view of an active device array substrate according to a third embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

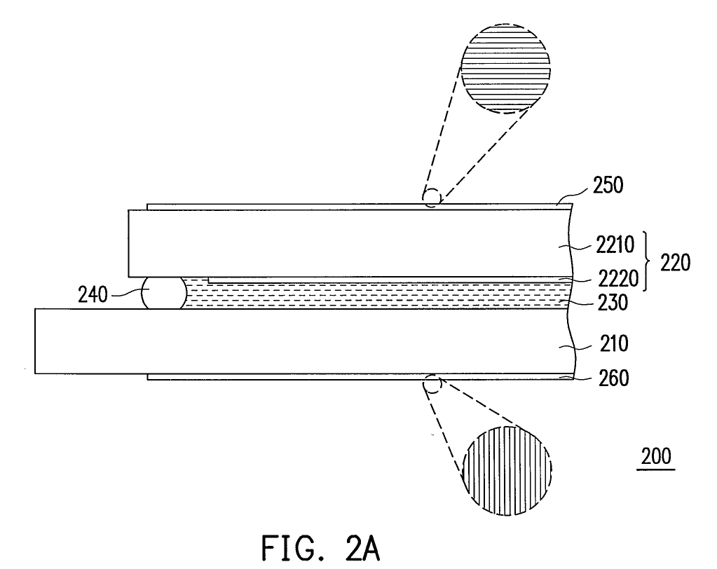

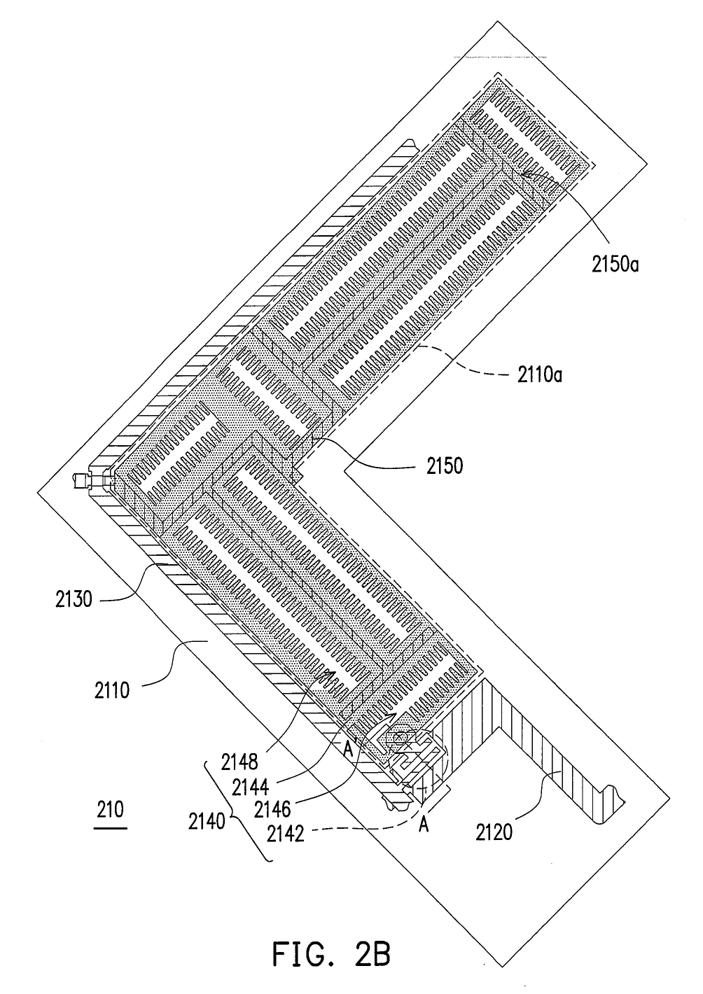

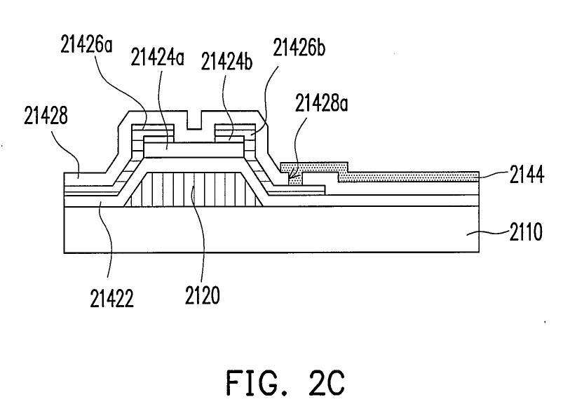

FIG. 2A is a schematic cross-sectional view of a multi-domain horizontal alignment liquid crystal display panel according to a first embodiment of the present invention. FIG. 2B is a top view of the active device array substrate of FIG. 2A. FIG. 2C is a cross-sectional view along line A-A′ of FIG. 2B. As shown in FIG. 2A, the multi-domain horizontal alignment liquid crystal display (MHA LCD) panel 200 in the present embodiment includes an active device array substrate 210, an opposing substrate 220, a liquid crystal layer 230, a plastic frame 240, a first polarizing plate 250 and a second polarizing plate 260. The liquid crystal layer 230 is disposed between the active device array substrate 210 and the opposing substrate 220. The plastic frame 240 is disposed between the active device array substrate 210 and the opposing substrate 220 and surrounds the liquid crystal layer 230. Additionally, the opposing substrate 220 includes a substrate 2210 and a common electrode layer 2220. The common electrode layer 2220 is disposed on the substrate 2210 and faces the liquid crystal layer 230. In the present embodiment, the opposing substrate 220 can be a color filter substrate.

The first polarizing plate 250 is disposed on the surface of the opposing substrate 220 far away from the liquid crystal layer 230. In other words, the first polarizing plate 250 is disposed on the upper surface of the opposing substrate 220. The second polarizing plate 260 is disposed on the surface of the active device array substrate 210 far away from the liquid crystal layer 230. In other words, the second polarizing plate 260 is disposed on the lower surface of the active device array substrate 210. In the present embodiment, the direction of polarization of the first polarizing plate 250 is set at a 0° angle from the horizontal direction and the direction of polarization of the second polarizing plate 260 is set at a 90 degree angle from the horizontal direction. However, in another embodiment, the arrangement can be reversed so that the direction of polarization of the first polarizing plate 250 is set at a 90 degree angle while the direction of polarization of the second polarizing plate 260 is set at a 0 degree angle from the horizontal direction. In other words, the MHA LCD panel 200 in the present embodiment has a normally dark display. Yet, the MHA LCD panel 200 can also deploy a normally white display. In this case, the first polarizing plate 250 and the second polarizing plate 260 have the same direction of polarization.

As shown in FIGS. 2B and 2C, the active device array substrate 210 in the present embodiment includes a substrate 2110, scan lines 2120, data lines 2130, pixel units 2140 and common lines 2150. The scan lines 2120, the data lines 2130 and the common lines 2150 are disposed on the substrate 2110. Furthermore, the scan lines 2120 and the data lines 2130 define L-shaped pixel areas 2110a on the substrate 2110. In addition, in the present embodiment, the scan lines 2120 and the data lines 2130 have a jagged shape. Each common line 2150 has T-shaped branches 2150a. In the present embodiment, the storage capacitor is constructed over the common line (Cst common). However, the storage capacitor can also be constructed on the gate (Cst on gate).

As shown in FIG. 2B, the pixel units 2140 are disposed on the respective L-shaped pixel areas 2110a. Furthermore, each pixel unit 2140 is controlled through a pair of corresponding scan line 2120 and corresponding data line 2130. More specifically, each pixel unit 2140 includes an active device 2142, a pixel electrode 2144, first alignment members 2146 and second alignment members 2148. The active device 2142 is electrically connected to the corresponding scan line 2120 and the data line 2130. The pixel electrode 2144 and the active device 2142 are electrically connected.

As shown in FIG. 2C, the active device 2142 in the present embodiment can be a thin film transistor. More specifically, the active device 2142 includes a first dielectric layer 21422, a semiconductor layer 21424a, an ohmic contact layer 21424b, a source 21426a, a drain 21426b and a second dielectric layer 21428. Part of the scan line 2120 serves as the gate of the active device 2142 and the first dielectric layer 21422 covers the scan line 2120. The semiconductor layer 21424a is disposed on the first dielectric layer 21422 above the scan line 2120. The ohmic contact layer 21424b is disposed on the semiconductor layer 21424a, and the source 21426a and the drain 21426b are disposed on the ohmic contact layer 21424b. The source 21426a and the data line 2130 are electrically connected. Additionally, the second dielectric layer 21428 covers the source 21426a and the drain 21426b. Furthermore, the second dielectric layer 21428 has a contact hole 21428a that exposes a portion of the drain 21426b. The pixel electrode 2144 is electrically connected to the drain 21426b through the contact hole 21428a.

In the present embodiment, a portion of the scan line 2120 serves as a gate of the active device 2142. However, the gate and the scan line 2120 can be independent structures. Furthermore, the pixel electrode 2144 can be a transmissive electrode, a reflective electrode or a transflective electrode. The transmissive electrode is fabricated using, for example, indium-tin-oxide (ITO) material, indium-zinc oxide (IZO) material or other transmissive conducting material.

As shown in FIG. 2B, the first alignment member 2146 and the second alignment member 2148 are disposed on the pixel electrode 2144. In the present embodiment, the first alignment member 2146 and the second alignment member 2148 are jagged slits. Yet, the first alignment member 2146 and the second alignment member 2148 can be ordinary rectangular slits. Furthermore, the first alignment member 2146 and the second alignment member 2148 are set in directions perpendicular to each other. Moreover, the first alignment member 2146 forms an included angle of 45 degree with the horizontal direction. Although the first alignment member 2146 and the second alignment member 2148 are slits in the present embodiment, they may also be alignment protrusions. It should be noted that to unify the image performance of various multi-domains, the total length of the first alignment members 2146 in each pixel unit 2140 can be equal or close to the total length of the second alignment members 2148. In the present embodiment, the L-shaped pixel areas 2110a can be roughly divided into two rectangular sub-pixel areas. Furthermore, each sub-pixel area can have both the first alignment member 2146 and the second alignment member 2148. Moreover, the common line 2150 on each sub-pixel area has the rough outline of the letter H.

According to the foregoing description, the MDA LCD panel 200 in the present embodiment comprises the advantages of a wide viewing angle and rapid response. In addition, the present invention has L-shaped pixel regions 2110a and modified direction of alignment for the first alignment member 2146 and the second alignment member 2148. Hence, the present invention can deploy ordinary X-Y axis polarizing plates to reduce production cost. Moreover, with the first polarizing plate 250 and the second polarizing plate 260 deploying ordinary X-Y axis polarizing plates, the chance of the MHA LCD panel 200 in the present invention having an edge mura problem can be reduced.

Because an alignment protrusion or a slit is also required on the opposing substrate 220, when the common line 2150 is located underneath the protrusion material of the opposing substrate 220, the common line 2150 forms part of a storage capacitor but will not affect the aperture ratio. Furthermore, the alignment protrusion on the opposing substrate 220 can also be disposed over the scan line 2120 or the data line 2130.

Since the alignment protrusion on the opposing substrate 220 will lead to some abnormality in the alignment of the liquid crystal molecules, the common line 2150 can serve as a light-shielding layer for minimizing light leakage or chromatic deviation and improving display quality and display contrast. Moreover, if the width of the common line 2150 is greater than the width of the alignment protrusion on the opposing substrate 220, no black matrix layer design is required in this area of the opposing substrate 220 so that the aperture ratio and the display contrast are increased.

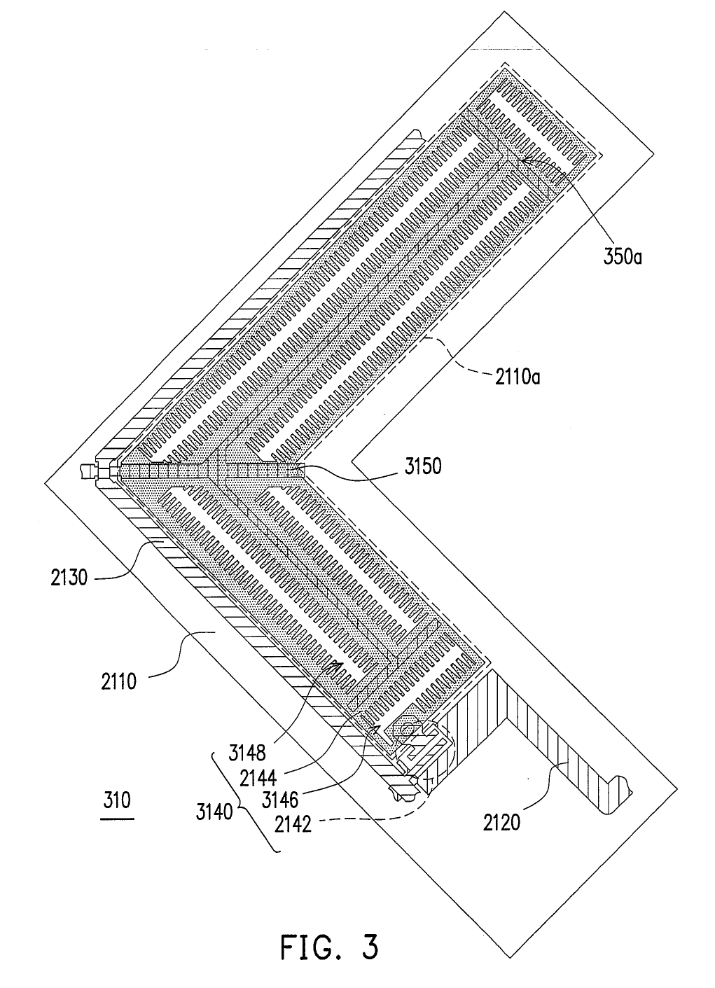

FIG. 3 is a top view of an active device array substrate according to a second embodiment of the present invention. As shown in FIG. 3, the structure of the active device array substrate 310 in the present embodiment is similar to that of the active device array substrate 210 of the first embodiment except for the alignment of the first alignment member 3146 and the second alignment member 3148 and the state of the common line 3150 in each pixel unit 3140. Similarly, the total length of the first alignment members 3146 is preferably identical to the total length of the second alignment members 3148. Furthermore, the first alignment members 3146 and the second alignment members 3148 are not limited to slits or jagged slits. The first alignment members 3146 and the second alignment members 3148 can also be alignment protrusions.

In addition, each common line 3150 can similarly has T-shaped branches 3150a. In the present embodiment, the L-shaped pixel area 2110a can be roughly divided into two trapezium sub-pixel areas. Moreover, both the first alignment member 3146 and the second alignment member 3148 are disposed on each sub-pixel area.

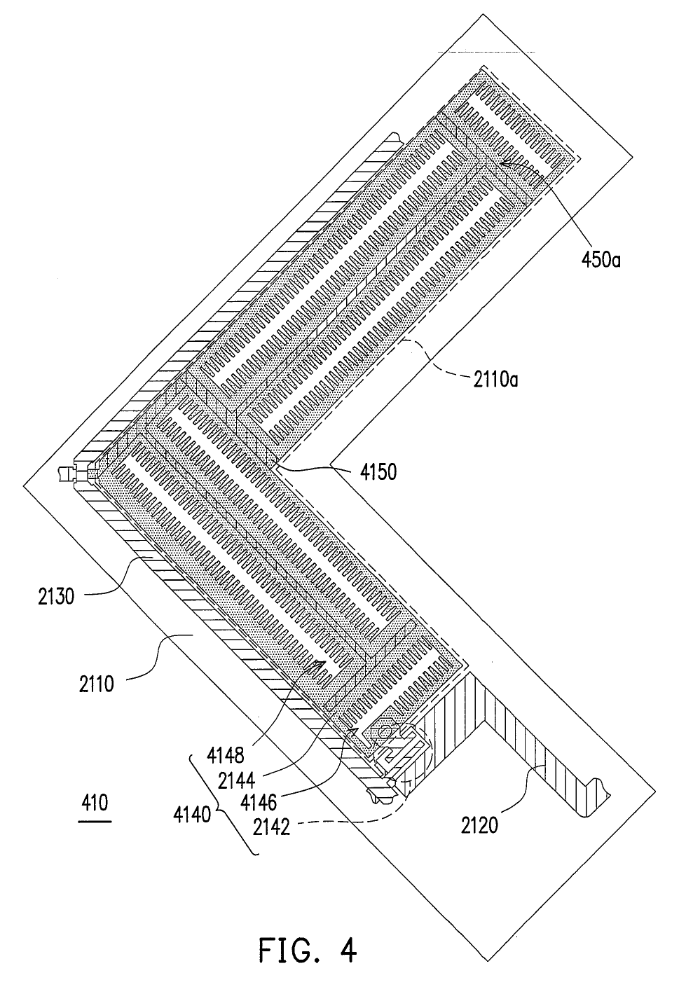

FIG. 4 is a top view of an active device array substrate according to a third embodiment of the present invention. As shown in FIG. 4, the active device array substrate 410 in the present embodiment is similar to the active device array substrate 210 in the first embodiment except for the alignment of the first alignment member 4146 and the second alignment member 4148 and the state of the common line 4150 in each pixel unit 4140. Similarly, the total length of the first alignment members 4146 is preferably identical to the total length of the second alignment members 4148. Furthermore, the first alignment members 4146 and the second alignment members 4148 are not limited to slits or jagged slits. The first alignment members 4146 and the second alignment members 4148 can also be alignment protrusions.

In addition, each common line 4150 can similarly has T-shaped branches 4150a. In the present embodiment, the L-shaped pixel area 2110a can be roughly divided into two rectangular sub-pixel areas. Moreover, both the first alignment member 4146 and the second alignment member 4148 are disposed on each sub-pixel area. It should be noted that the orientation of the first alignment member 4146 and the second alignment member 4148 could have other modifications. The pixel areas can have a Z shape. In other words, the pixel area comprises three connected rectangular sub-pixel areas.

In summary, major advantages of the multi-domain horizontal liquid crystal display panel in the present invention includes at least the following advantages:

1. Compared to the conventional technique, the present invention uses an L-shaped pixel area with a modified alignment for the first alignment member and the second alignment member. Therefore, the present invention can deploy ordinary X-Y oriented polarizing plates to lower the production cost.

2. Because ordinary X-Y oriented polarizing plates can be deployed in the present invention, the chance of having an edge mura problem in the present invention can be reduced.

3. The present invention is compatible with the existing five-photomask process.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi-domain horizontal alignment liquid crystal display (MHA LCD) panel, comprising:
an active device array substrate, having:
a substrate;
a plurality of scan lines disposed on the substrate;
a plurality of data lines disposed on the substrate, wherein the scan lines and the data lines together define a plurality of L-shaped pixel areas on the substrate;
a plurality of pixel units disposed on the respective L-shaped pixel areas such that the pixel unit is controlled through the scan line and the data line, wherein each pixel unit further comprises:
an active device electrically connected to the corresponding scan line and the corresponding data line;
a pixel electrode electrically connected to the active device;
a plurality of first alignment members disposed on the pixel electrode such that the first alignment members form a 45 degree included angle with the horizontal direction;
a plurality of second alignment members disposed on the pixel electrode such that the first alignment members are set in a direction perpendicular to the second alignment members;
an opposing substrate having a common electrode layer; and
a liquid crystal layer disposed between the active device array substrate and the opposing substrate.

2. The MHA LCD panel of claim 1, wherein the panel also comprises:
a first polarizing plate disposed on the surface of the opposing substrate far away from the liquid crystal layer; and
a second polarizing plate disposed on the surface of the active device array substrate far away from the liquid crystal layer, wherein the direction of polarization of the first polarizing plate is either at a 0 or a 90 degree angle with respect to the horizontal direction, and the direction of polarization of the second polarizing plate is also at a 0 or a 90 degree angle with respect to the horizontal direction but complementary to that of the first polarizing plate.

3. The MHA LCD panel of claim 1, wherein the active device array substrate further includes a plurality of common lines disposed on the substrate.

4. The MHA LCD panel of claim 3, wherein each common line has a plurality of T-shaped branches.

5. The MHA LCD panel of claim 1, wherein the total length of the first alignment members in each pixel unit is the same as the total length of the second alignment members.

6. The MHA LCD panel of claim 1, wherein each scan line has a jagged shape.

7. The MHA LCD panel of claim 1, wherein each data line has a jagged shape.

8. The MHA LCD panel of claim 1, wherein the first alignment members include alignment protrusions or slits.

9. The MHA LCD panel of claim 1, wherein the second alignment members include alignment protrusions or slits.
